(19) United States
(12) Patent Application Publication
(10) Pub. No.: US 2023/0233989 A1
(43) Pub. Date: Jul. 27, 2023

(54) SYSTEM AND METHOD FOR DIRECT AIR CAPTURE OF WATER AND CO2

(71) Applicant: Battelle Memorial Institute, Richland, WA (US)

(72) Inventors: B. Peter McGrail, Pasco, WA (US); Radha K. Motkuri, Richland, WA (US)

(73) Assignee: Battelle Memorial Institute, Richland, WA (US)

(21) Appl. No.: 18/099,550

(22) Filed: Jan. 20, 2023

Related U.S. Application Data
(60) Provisional application No. 63/303,407, filed on Jan. 26, 2022.

(51) Int. Cl. B01D 53/26; B01D 53/047

(52) U.S. Cl. CPC B01D 53/261; B01D 53/047; B01D 2257/80; B01D 2257/504; B01D 2259/40083

(57) ABSTRACT

An apparatus that includes (A) an atmospheric water extraction unit; and (B) a direct air capture unit positioned downstream of and in communication with the atmospheric water extraction unit, wherein the apparatus is capable of reversibly operating in (i) adsorption mode to adsorb water and CO₂ from an incoming air stream and (ii) regeneration mode to release adsorbed water and CO₂, wherein the atmospheric water extraction unit comprises a first desiccant bed comprising a sorbent that adsorbs water from an incoming air stream during adsorption mode and releases water during regeneration mode, and wherein the direct air capture unit comprises a first moisture-responsive CO₂ sorbent bed comprising a sorbent that adsorbs CO₂ from an air stream during adsorption mode and releases CO₂ upon contact with water vapor during regeneration mode.

### CROSS-REFERENCE TO RELATED APPLICATION

This application claims the benefit of U.S. Provisional Application No. 63/303,407 filed on Jan. 26, 2022 which is incorporated herein in its entirety.

### ACKNOWLEDGMENT OF GOVERNMENT SUPPORT

This invention was made with government support under Contract No. DE-AC05-76RL01830 awarded by the U.S. Department of Energy. The government has certain rights in the invention.

### BACKGROUND

Capture of dispersed greenhouse gases (GHGs) is an important part of a diversified portfolio of technologies to mitigate GHG emissions. A large portion of the 5.2 gigatons (Gt) of CO₂ emitted each year in the United States is released in relatively small quantities from distributed sources (e.g., from small point sources or some transportation sources). For such emissions, point source capture may be infeasible. In those cases, capture of dispersed CO2 serves as a crosscutting and complementary approach to achieving economy-wide net-zero emissions.

Industrial direct air capture systems (DAC) are available such as the Climeworks porous sorbent system (Spiteri et al., Patent No. Application US 20200061519 and Carbon Engineering’s design around a KOH—CaCO₃ process capable of generating 1 MMT or more of CO₂ per year (Keith et al., 2018, Joule 2(8):1573-1594). As in most current DAC systems, the CO₂ recovery process involves introduction of heat (Fasihi et al., 2019, J. Clean. Prod. 24:957-980). In sorbent-based systems, the most significant exergetic losses occur from cyclic heating and cooling both the sorbent and the associated mass of heat exchange materials and structural supports. Kulkarni and Sholl 2012, Ind. Eng. Chem. Res. 51(25):8631-8645) estimated a second law efficiency of 7.4% for a typical temperature swing adsorption (TSA) DAC system, which might be improved to about 11.6% with a higher capacity sorbent. From the detailed thermodynamic analysis provided by Keith et al. (2018) for the Carbon Engineering design, one arrives at a second law efficiency of 8.3% including CO2 compression to 150 bar. However, this estimate does not include the total energy (or environmental) cost of supplying the 4.7 tons of water consumed for every ton of CO₂ produced in the process. Indeed, in a recent paper by Fuhrman et al. (2020) Nat. Clim. Chang. 10:920-927, water consumption from deployment of conventional DAC technology was shown to have multiple negative economic impacts offsetting the climate change mitigation benefits of DAC to a significant degree.

One possible alternative is a moisture or humidity swing DAC process. In moisture swing adsorption (MSA), exposure to high relative humidity results in water displacing CO₂ that had been adsorbed under dry conditions (He et al., 2013 Energ. Environ. Sci. 6(2):488-493, Yang et al., 2018, Chem. Comm. 54(39):4915-4918). In theory, this process eliminates the heat transfer requirements that severely limit the thermodynamic efficiency in TSA designs. However, of the several published papers on MSA systems for DAC (Wang 2011, 45(15):6670-6675, Shi 2020, Angew. Chem. Int. Edit. 59(18):6984-7006,), the critical management of water in the cycle has received little attention regarding the nearly 5 moles of clean water consumed per mole of CO₂ produced (Wang et al. 2013, Phys. Chem. Chem. Phys. 15(2):504-514) or the heat transfer implications of the adsorption/desorption of this much water during the MSA cycle.

### SUMMARY

Disclosed herein is an apparatus comprising:
(A) an atmospheric water extraction unit; and
(B) a direct air capture unit positioned downstream of and in communication with the atmospheric water extraction unit,
wherein the apparatus is capable of reversibly operating in (i) adsorption mode to adsorb water and CO₂ from an incoming air stream and (ii) regeneration mode to release adsorbed water and CO₂,
wherein the atmospheric water extraction unit comprises a first desiccant bed comprising a sorbent that adsorbs water from an incoming air stream during adsorption mode and releases water during regeneration mode, and
wherein the direct air capture unit comprises a first moisture-responsive CO₂ sorbent bed comprising a sorbent that adsorbs CO₂ from an air stream during adsorption mode and releases CO₂ upon contact with water vapor during regeneration mode.

Also disclosed herein is a method comprising operating the apparatus disclosed herein in (A) adsorption mode to remove water and CO₂ from a first air stream and (B) regeneration mode to release adsorbed water and CO₂,
wherein adsorption mode comprises:
   (a) contacting the first air stream with the first desiccant bed to reduce the water content of the stream and create a second air stream having a reduced water content relative to the first stream;
   (b) contacting the second air stream with the first moisture-responsive CO₂ sorbent bed to reduce the CO₂ content of the stream and release water from the bed to create a third stream having a reduced CO₂ content relative to the first and second air streams, and a water content that is higher than the water content of the second stream but lower than the water content of the first stream; and
   (c) exhausting the third stream to ambient atmosphere; and
wherein regeneration mode comprises:
   (a) releasing water adsorbed by the first desiccant bed to create a water vapor stream;
   (b) contacting the water vapor stream with the first moisture-responsive CO₂ sorbent bed to release CO₂ adsorbed by the bed and to adsorb water from the water vapor stream to create a discharge stream comprising water vapor and CO₂; and
   (c) passing the discharge stream through one or more condensers and compressors to create (i) a liquid water condensate discharge and (ii) a CO₂ stream.

The foregoing will become more apparent from the following detailed description, which proceeds with reference to the accompanying figures.

### BRIEF DESCRIPTION OF THE DRAWINGS

FIG. 1 is a schematic of a first embodiment of a hybrid direct air capture (HDAC) system disclosed herein that utilizes atmospheric water extraction (AWE) coupled with CO₂ moisture swing adsorption (MSA). This embodiment encloses both the AWE and MSA sorbent beds in a single chamber.

FIG. 2 is schematic of the operating states of the first embodiment of the HDAC system disclosed herein.

FIG. 3 is a schematic of a second embodiment of a hybrid direct air capture (HDAC) system that has separate chambers for the AWE and MSA sorbent beds.

FIG. 4 is process flow diagram representing the required unit operations for the first embodiment of the HDAC system.

FIG. 5 is a perspective view of a radiator design for beds disclosed herein.

### DETAILED DESCRIPTION

The hybrid direct air capture (HDAC) systems and methods disclosed herein simultaneously overcome the largest barriers that drive up costs for conventional DAC systems: 1) complex and numerous unit operations that incur high capital and operating costs, 2) low thermodynamic efficiency and consequent high energy consumption per ton of CO₂ produced, and 3) high consumption of water, which may constrain deployment in water-challenged locations. The HDAC systems and methods disclosed herein simultaneously capture CO₂ and water from air. The HDAC systems and methods produce a large amount of potable water along with CO₂, which enhances siting options where water scarcity is an issue, provides a second source of revenue that improves financial returns, and magnifies the environmental benefits of removing CO₂ from the atmosphere. The high purity water produced by the HDAC systems and methods can also be used directly as a feedstock for electrolysis producing hydrogen, which along with the CO₂ produced, can be used to produce carbon neutral, or low carbon footprint fuels. As described below in detail, the HDAC systems and methods disclosed herein have a small number of unit operations, thereby simplifying the overall process. In certain embodiments, the HDAC systems and method disclosed herein have an overall CO₂ capture efficiency of at least 50%, more particularly at least 60%, and an overall water removal efficiency of at least 50%, more particularly at least 65%.

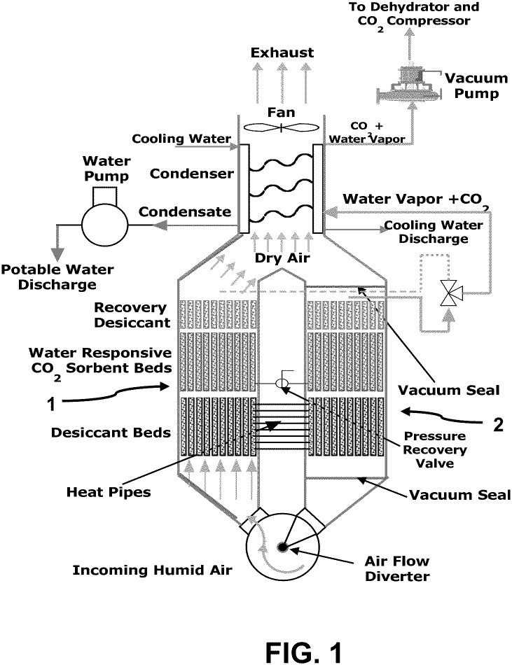

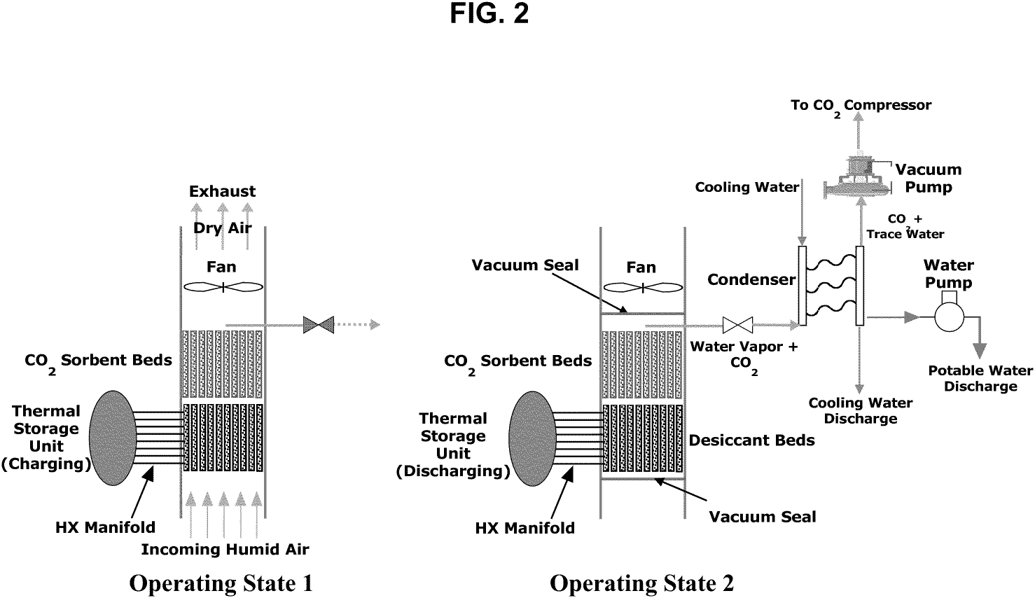

HDAC combines atmospheric water extraction (AWE) with CO₂ moisture swing adsorption (MSA), with AWE providing the pure water needed to regenerate the MSA. An example embodiment of such a system and method is shown in FIG. 1. An operating state schematic is given in FIG. 2. Because the adsorption and regeneration cycles of the AWE and MSA sorbents work in opposite operating states, integrating them in HDAC provides a very efficient means to balance the water demands required to produce CO₂.

In one illustrative embodiment shown in FIG. 2, in Operating State 1, water is removed from the incoming air stream by passing through a first (primary) desiccant bed. In certain embodiments, sufficient water is removed to reduce the relative humidity (RH) of the air stream from ambient RH to preferably between 25 to 15% RH. The now relatively dry air stream is passed through the water responsive CO₂ sorbent bed for CO₂ removal. The dry air stream removes water from the MSA thus restoring its affinity to capture CO₂. In certain embodiments, 40 to 50 percent, more particularly 60 to 70 percent, of the CO₂ is removed by the water responsive CO₂ sorbent. If desired, the water released from the CO₂ sorbent to the air can be recaptured in a second desiccant bed that includes a recovery desiccant designed for extracting water vapor from air at low RH.

In the opposite chamber (FIG. 1) running in Operating State 2, a partial vacuum is applied. Vacuum pressure between 10 to 50 mbar is applied depending on the ambient air temperature. Water vapor is released from the desiccant and flows through the CO₂ sorbent bed. A portion (typically <10%) of the water is adsorbed by the moisture responsive sorbent and CO₂ is released to form a mixture of water vapor and CO₂. Water is also released from the recovery desiccant if used in the system. This gas mixture then is then drawn into a condenser by a primary vacuum pump where the majority of the water is condensed out. The remaining CO₂ + water vapor stream is compressed by the vacuum pump and passed through a second condenser stage to remove additional water. After one additional compression-condensation stage, the CO₂ stream is passed through a dehydrator to remove the residual water sufficiently to achieve commercial pipeline specification of <500 ppmv water. The dry CO₂ is then compressed up to a desired pipeline pressure such as between 60 to 100 bar. At the conclusion of the regeneration cycle, the chamber in Operating State 2 is switched to Operating State 1 and vice versa. The cycle time for the system may range between 90 to 1200 s, with the preferred cycle time between 300 to 600 s.

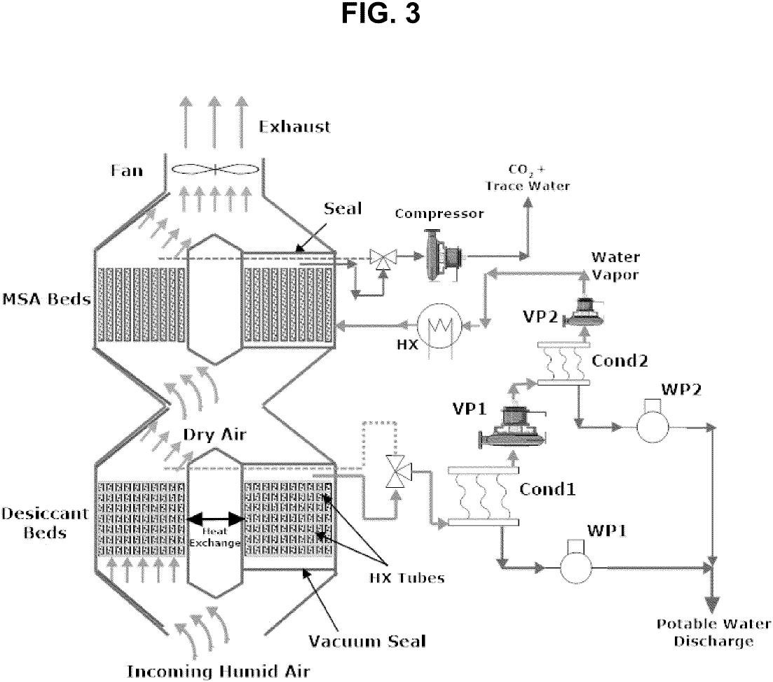

In a second embodiment shown in FIG. 3, there is a first section containing the desiccant beds and a second section containing the MSA beds, wherein the first section and the second section are physically separated from each other. This embodiment is advantageous if the MSA can generate higher CO₂ pressures, for example 360 mbar, thus reducing compression power for the CO₂. In this embodiment, water vapor from the second stage vacuum pump is cooled and then injected into the separate DAC chamber to provide the water required for CO₂ removal from the MSA.

### Atmospheric Water Extraction (AWE) Section

The AWE section of the systems disclosed herein includes one or more nanostructured desiccant porous materials configured to adsorb water from the air inlet stream at a first pressure and to release water from that material when subjected to a second pressure with the second pressure lower than the first air pressure. A preferred embodiment for the first pressure is at ambient air pressure with the second pressure being a partial vacuum between 10 to 50 mbar depending upon ambient air temperature. A second embodiment would have a first pressure above ambient such as between 2 to 4 bar while the second pressure is at ambient pressure.

Preferably, the desiccant materials are located within a structured support such as a desiccant bed, although other configurations including 3D arrangements including configuration in rods, coatings on fins or other structures are also envisioned in certain applications. Multiple numbers of these structures can be interconnected with or without connection to other features such as heat pipes, heat exchange tubes, or seals. Desiccants with different adsorption properties may be assembled in sequence along the air flow path to optimize water extraction from the air stream. In a preferred embodiment, a vacuum pump is connected to the system and is adapted to provide suction to the desiccant materials sufficient to lower the pressure and remove water from desiccants thus regenerating the adsorption material. In a second embodiment, an air compressor is used to supply air at the first pressure, which flows through the desiccant beds under pressure. An expander may be included to recover some of the compression energy from the exhaust. Regeneration occurs at the second pressure, which may range between 100 mbar and ambient atmospheric pressure.

In some embodiments, the desiccant materials may be a metal-organic framework (MOF) material, zeolite, mesoporous silica, a covalent organic framework material, a porous organic polymer, or porous carbon.

The MOFs are porous metal organic frameworks or hybrid organic inorganic materials that include at least one metal component selected from the group consisting of Zn, Fe, Al, Mg, V, Ni, Mn, Co, Sc, Y, Ti, Zr, Hf, Nb, Ta, Cr, Mo, W, Tc, Re, Ru, Os, Ir, Pd, Pt, Cu, Ag, Au, Hg, Sr, Ba, Ga, In, Tl, Si, Ge, Sn, Pb, Sb, Bi, and combinations thereof.

Divalent metal ions including Ni⁺², Zn⁺², Cu⁺², Co⁺², Mg⁺², Ca⁺², Fe⁺², Mn⁺², and the like, and trivalent metal ions such as Fe⁺³, Al⁺³, Cr⁺³, Mn⁺³, and the like, may be incorporated in the metal organic frameworks. In another embodiment, the porous metal organic frameworks may be formed by coordination with tetravalent, pentavalent or hexavalent metal ions of Zr, Ti, Sn, V, W, Mo or Nb.

In certain embodiments, along with univalent metals ions, mixed metals containing divalent, trivalent oxidation states are incorporated in metal organic frameworks also known as Prussian blue analogues with chemical formula of M⁺³₃[M⁺²(CN)₆]₂ where M⁺³ can be Fe⁺³, CO⁺³, Mn⁺³ etc and M⁺² can be Zn⁺², Ni⁺², Co⁺², Mn⁺², Cu⁺² and the like, and mixtures thereof.

An organic building block in the porous metal organic framework materials is referred to as a linker or organic linker. In one embodiment, the organic linker has a functional group capable of coordination. Examples of functional groups that can be coordinated with these metal ions include but are not limited to, carbonic acid (—CO₃H), anionic form of carbonic acid (—CO₃⁻ ), carboxyl anion group of carboxylic acid, amino group (—NH₂), imino group, hydroxyl group (—OH), amido group (—CONH₂), sulfonic acid group (—SO₃H), anionic form of sulfonic acid (—SO₃), cyanide (—CN), nitrosyl (—NO), and pyridine. For example, in one embodiment the chemical formula T[Fe(CN)₅NO] where T=Mn, Fe, Co, Ni, Cu, Zn, and Cd; also mixed compositions include Co₁₋ₓTₓ[Fe(CN)₅NO]; T=Mn, Fe, Ni, Zn, and Cd etc. also known as nitroprussides.

In certain embodiments, the organic ligand may include compounds having at least two sites for coordination, for example, bi-, tri-, tetra-, penta-, hexadentate ligands. Non-limiting examples of these organic compounds may be a neutral linker such as pyrazine, dabco, piperazine, bypyridine, azobenzene and functionalized forms of these neutral ligands etc., anionic organic compounds including anions of carboxylic acid such as, terephthalate, naphthalenedicarboxylate, benzenetricarboxylate, benzenetetracarboxylate, benzenepentacarboxylate, benzenehexacarboxylate, dioxo-terephthalate, etc. Anions of aromatic and other linear carboxylic acid anions include formate, oxalate, malonate, succinate, glutamate etc., and nonaromatic carboxylate anions including 1,2-cyclohexanedicarboxylate, 1,3-cyclohexanedicarboxylate, 1,4-cyclohexanedicarboxylate and 1,3,5 cyclohexane tricarboxylate can be used to prepare the hybrid organic inorganic materials.

Other organic linkers including various heterocyclic materials including, furan, indole, pyridine-2,3-dicarboxylate, pyridine-2,6-dicarboxylic acid, pyridine-2,5-dicarboxylic acid and pyridine-3,5-dicarboxylicacid, and the like.

Other organic linkers to produce a sub-class of metal organic frameworks called zeolite imidazolate frameworks generated using imidazole, tetrazole, triazole, and functionalized with Cl, Br, I, F, NH₂, and NO₂.

In another embodiment, the organic ligand can be dihydroxyterephthalate and its derivatives. In a non-limiting example, dihydoxyterephthalate having, chloro, bromo, iodo, fluoro, cyano, sulphonato, amino, aldehyde, and carbamide. Similarly, organic building blocks can be functionalized with di-, tri-, tetra,-pentaterephthalate containing at least one or more functional groups such as nitro, amino, bromo, chloro, iodo, and amino.

In certain embodiments, the desiccant comprises a covalent organic frameworks. Covalent organic frameworks (COFs) or porous aromatic frameworks (PAFs) or porous polymer networks (PPNs) are porous crystalline extended aromatic framework materials where the organic building blocks are linked by strong covalent bonds. The attractiveness behind these materials was exclusively use of light elements such as H, B, C, N and O which are known to form well established materials (ex: graphite, diamond, boron nitride etc) with strong covalent bonds. The fine tunability of the organic building block with various functional groups, extending the size, lead to the formation of lightweight functionalized micro/meso porous covalent frameworks with desired applications. Covalent organic framework type materials include those generated by condensation of diboronic acid, hexahydroxytriphenylene, dicyanobenzene and its derivatives of chemical formula C₉H₄BO₂, and those generated from benzene-1,4-diboronic acid (BDBA), 2,3,6,7,10,11-hexahydroxyltriphenylene (HHTP), tetrakis(4-bromophenyl)methane, Tetrakis(4-ethynylphenyl)methane (TEPM), 1,3,5,7-Tetrakis(4-ethynylphenyl)adamantine (TEPA), 1,3,5,7-Tetrakis(4-bromophenyl)adamantine (TBPA).

In certain embodiments, the desiccant is MOF 303, 801, or 841, with MOF 303 or 801 showing the best performance in some circumstances. MOF 303 is an aluminum-based MOF. MOF 801 and MOF 841 are zirconium-based MOFs.

A preferred embodiment provides pairs or sets of desiccant beds or other structures within an air passage pathway that allows for contact between the humid air and the desiccant materials. The air continually dries while moving across these structures. This can allow for serial drying and increased efficiencies by use of different desiccants that adsorb water more effectively from air at higher relative humidity versus others that are more effective at lower relative humidity. In addition, the passageways to these structures can be opened and closed to allow for one set to be in a dehumidifying operation at the first operating pressure while in another section water is removed from the system and the desiccant regenerated at the second operating pressure.

The water adsorbed by the desiccant materials spontaneously results in the generation of heat, which can be as much as 3000 kJ/kg-H₂O or even more with some desiccants. An equal and opposite amount of heat is consumed when water is removed from the desiccants during regeneration. In a preferred embodiment, the heat of adsorption is used to enhance regeneration of the desiccant materials by providing the heat required during regeneration at the second operating pressure in the apparatus. Heat can be conveyed to these materials passively though interconnected heat pipes, or actively by pumping a heat transfer fluid through tubes, plates, pipes or other means of conveying a heat transfer fluid from the parts of the system undergoing adsorption to the beds or structures that are undergoing regeneration. In a preferred embodiment, the desiccant materials are bonded to a thermally conductive support such as aluminum that provides: 1) Efficient conveyance of the heat of adsorption/desorption to the heat pipes or other heat transfer system used to interconnect the parts of the system, and 2) Efficient exposure of the desiccant materials to the air stream to increase rate of water uptake.

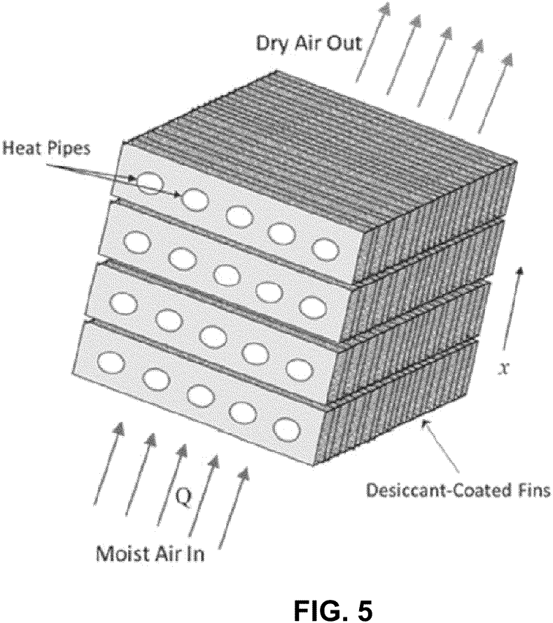

FIG. 5 shows an example of a tube-fin design desiccant bed system formed similarly to a radiator with a set of thermally conductive fins made of a very lightweight material like aluminum coated with desiccant. As air flows through the channels between the fins and water is adsorbed by the desiccants generating heat, the tubes convey a heat transfer fluid to a header that is connected to an identical set of desiccant beds undergoing regeneration and thus consuming heat. A heat transfer simulation of this design shows that with sufficient flow rate of heat transfer fluid, temperature differential between the chambers can be kept below 5° C. This confirms the design premise in being able to thermally couple the adsorption-desorption chambers and operate the AWE system approximately isothermally.

### Direct Air Capture (DAC) Section

In a preferred embodiment of HDAC, an isothermal AWE section as described in U.S. Pat. App. Publ. 2021/0055010 and also described above is used to provide water vapor to perform a humidity swing to release CO₂ from a moisture responsive sorbent. In one embodiment illustrated in FIG. 1, the HDAC system design merges AWE with MSA into two chambers or trains with a first train 1 that is capturing water and CO₂ from the air flow, while a second opposing train 2 is being regenerated. This provides for continuous production of CO₂ and water and utilizes the heat exchange principles described previously in the AWE section to balance the heat requirements between the chambers. A similar heat balancing method could be used in the DAC section but because the heat of adsorption of CO₂ is typically only about 1100 kJ/kg-CO₂ and there is much smaller CO₂ mass flow rate as compared with water, there is little benefit to implementing this heat exchange method in the DAC section.

Dispersed within each of the first and second chamber are: 1) Desiccant beds composed of one or more desiccant materials dispersed on thermally conductive support, 2) Water responsive CO₂ adsorbent(s), and 3) optionally, a recovery desiccant. The recovery desiccant is used to capture water vapor released from the MSA during its regeneration phase. In certain embodiments, each of the first chamber and the second chamber may be annular passages through which flowing air can contact the primary desiccant, a water responsive CO₂ adsorbent, and the recovery desiccant (if present). The first chamber and the second chamber may be arranged so that they are parallel to each other.

The primary desiccant, the water responsive CO₂ adsorbent, and the recovery desiccant (if present) are arranged relative to the location of the air inlet so that incoming air flows through the first chamber or the second chamber in the following sequence: primary desiccant, any secondary desiccants (if used), water responsive CO₂ adsorbent, and recovery desiccant (if present). In other words, the primary desiccant is proximate to the air inlet, the recovery desiccant (if present) is proximate the exhaust outlet, and the water responsive CO₂ adsorbent is interposed between the primary desiccant and the recovery desiccant.

The apparatus includes at least one air inlet. An air flow diverter may be disposed at the air inlet for directing the incoming air flow into the first chamber or the second chamber depending on the respective regeneration states of the primary desiccant and the water responsive CO₂ adsorbent.

The apparatus includes at least one exhaust outlet. Air that has been passed through the primary desiccant and the water responsive CO₂ adsorbent is exhausted from the apparatus via the exhaust outlet.

To perform regeneration, a preferred embodiment implements a seal on one chamber where a vacuum is applied. A seal may be formed using any of a variety of methods that include swinging, sliding, or rotating a door to seat against a sealing material, such as an O-ring, gasket, flange, or other sealing material. In an example of one embodiment that allows switching seals between chambers to cycle operating states, vacuum applied to the chamber with a door seated against the seal causes compression of the door and sealing material to form an air-tight seal. After evacuation of residual air from the chamber, the drop in pressure causes water vapor to desorb from the desiccants. By placing an intake manifold at the top of the chamber to distribute the intake vapor flow, the water vapor flow from the desiccants can be evenly distributed through the MSA bed. A portion of the water vapor, usually <10%, is adsorbed by the MSA. The adsorption process releases CO₂ from the MSA, which then flows up to the manifold along with the remaining water vapor and is removed from the chamber by the vacuum pump.

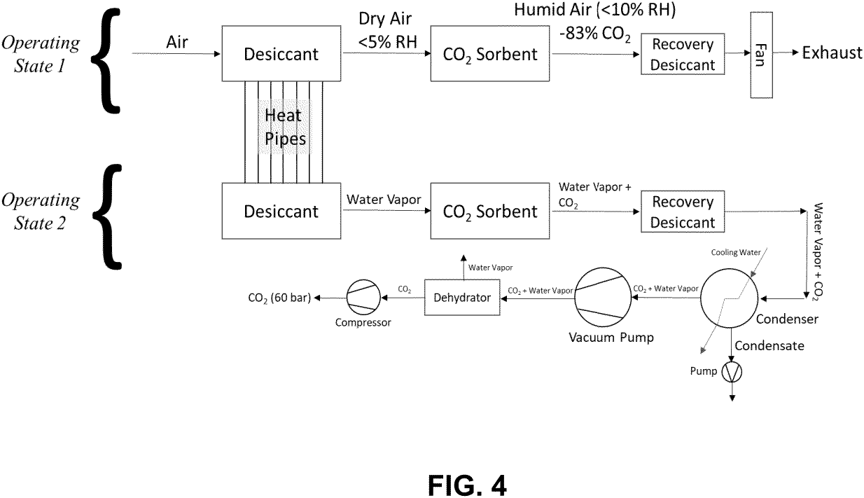

As illustrated in the process flow diagram (FIG. 4) in a preferred embodiment, the water vapor and CO₂ mixture is first passed through a condenser apparatus to remove a significant fraction of the water from the stream. An example condenser design that implements a microchannel heat exchanger architecture where water vapor flows into a header, which is then distributed to channels that reduce in width down to 1 mm or less. A single plate is formed into a stack with multiple channels sufficient to accommodate the design basis water production from the HDAC system. The vapor entering the header is cooled in the channels allowing condensation to occur. Condensate and vapor are discharged from the condenser and separated by gravity. The vapor is then further compressed and passed through a secondary condenser operating at higher pressure that Cond1. Additional water vapor is condensed out in Cond2. Additional compression-condensation stages can be included as shown in FIG. 4 to further reduce the water content in the CO₂ stream. As shown in FIG. 4, a series of water pumps is used to raise the pressure of the condensate up to atmospheric pressure for discharge. This step consumes little energy due to the incompressibility of liquid water.

If desired before compression to higher pressures such as for pipeline transport, a drying system such as drierite or triethylene glycol can be implemented to remove residual water vapor sufficient to achieve pipeline specifications of <500 ppmv water. As illustrated in FIG. 4, if compression to high pressure (60 to 100 bar) is needed, this step can be done with any commercial multistage CO₂ compressor system.

In another embodiment shown in FIG. 3, the MSA beds may be placed in separate chambers or sections from the desiccant beds. This arrangement could have energy consumption advantages if an MSA sorbent can generate somewhat higher CO₂ pressures, such as between 100 and 300 mbar, under regeneration. In this embodiment, water vapor is provided from the AWE section after at least two stages of compression-condensation to match the CO₂ pressure being generated by the MSA.

In certain embodiments, the MSA CO₂ adsorbent includes a hierarchically porous material that is functionalized with quaternary ammonium groups.

A preferred embodiment of MSA materials utilizes porous materials that have been initially functionalized with amine groups. The amine functional groups in the porous materials are then converted to quaternary ammonium species by post-synthesis modification via alkylation reactions or other well-established methods. In a preferred embodiment, the equilibrium MSA loading at 25° C. in air at 420 ppmv of CO₂ is at least 0.3 to 0.5 mmol/g, more particularly 0.8 to 2 mmol/g.

Porous materials may be macroporous (pore diameter larger than 50 nm), mesoporous (having a pore diameter or a pore size distribution between 2 and 50 nm), microporous (having a pore diameter or a distribution of pores smaller than 2 nm) or any combination of macro, meso or microporous pore distributions.

The porous materials described herein can be characterized as possessing two or more continuous phases (e.g., a void phase and a solid phase). The two or more phases are generally tortuous, such that the two or more phases are interpenetrating. The solid phase may be inorganic, organic or combination of the two.

In some embodiments, substantially all of the pores in the porous material are open pores, and substantially none of the pores are closed pores. Closed pores are defined as pores which are completely surrounded by solid material, whereas open pores are defined as pores that are not completely surrounded by solid material. Thus in open porous materials (i.e., porous materials wherein substantially all of the pores in the porous material are open pores), substantially all of the pores in the material are part of a continuous void phase.

In certain embodiments, the moisture responsive CO₂ sorbent is dispersed on a substrate such as a fiber or non-woven mat.

In other embodiments, the moisture responsive CO2 sorbent may be formed as a chemically homogeneous structured sorbent material made completely of the moisture responsive CO₂ sorbent. Such structured adsorbents may be in fiber form, monolith form, or any number of architectures formed by appropriate manufacturing processes.

In view of the many possible embodiments to which the principles of the disclosed invention may be applied, it should be recognized that the illustrated embodiments are only preferred examples of the invention and should not be taken as limiting the scope of the invention.

What is claimed is:

1. An apparatus comprising:
(A) an atmospheric water extraction unit; and
(B) a direct air capture unit positioned downstream of and in communication with the atmospheric water extraction unit,
wherein the apparatus is capable of reversibly operating in (i) adsorption mode to adsorb water and CO₂ from an incoming air stream and (ii) regeneration mode to release adsorbed water and CO₂,
wherein the atmospheric water extraction unit comprises a first desiccant bed comprising a sorbent that adsorbs water from an incoming air stream during adsorption mode and releases water during regeneration mode, and
wherein the direct air capture unit comprises a first moisture-responsive CO₂ sorbent bed comprising a sorbent that adsorbs CO₂ from an air stream during adsorption mode and releases CO₂ upon contact with water vapor during regeneration mode.

2. The apparatus of claim 1 wherein:
(A) the atmospheric water extraction unit further comprises a second desiccant bed, the second desiccant bed comprising a sorbent that adsorbs water from an incoming air stream during adsorption mode and releases water during regeneration mode; and
(B) the direct air capture unit further comprises a second moisture-responsive CO₂ sorbent bed, the second moisture-responsive CO₂ sorbent bed comprising a sorbent that adsorbs CO₂ from an air stream adsorption mode and releases CO₂ upon contact with water vapor during regeneration mode,
wherein the apparatus is configured such that the first desiccant bed and the first moisture-responsive CO₂ sorbent bed form a first train and the second desiccant bed and the second moisture-responsive CO₂ sorbent bed form a second train that is separate from the first train,
wherein the first and second trains are capable of reversibly operating in (i) adsorption mode to adsorb water and CO₂ from an incoming air stream and (ii) regeneration mode to release adsorbed water and CO₂,
wherein the first and second trains are configured such that the first train operates in adsorption mode when the second train operates in regeneration mode and the second train operates in adsorption mode when the first train operates in regeneration mode.

3. The apparatus of claim 2 wherein the first desiccant bed is thermally coupled to the second desiccant bed.

4. The apparatus of claim 1 wherein the atmospheric water extraction unit and the direct air capture unit are configured such that water adsorbed by the first desiccant bed during adsorption mode is released and contacts the first moisture-responsive CO₂ sorbent bed during regeneration mode to release adsorbed CO₂.

5. The apparatus of claim 2, wherein the first and second trains are configured such that water adsorbed by the first or second desiccant bed during adsorption mode is released and contacts the first or second moisture-responsive CO₂ sorbent bed during regeneration mode to release adsorbed CO₂.

6. The apparatus of claim 1 further comprising a first recovery desiccant bed arranged downstream of and in communication with the first moisture-responsive CO₂ sorbent bed.

7. The apparatus of claim 2 further comprising a first recovery desiccant bed arranged downstream of and in communication with the first moisture-responsive CO₂ sorbent bed and a second recovery desiccant bed arranged downstream of and in communication with the second moisture-responsive CO₂ sorbent bed.

8. The apparatus of claim 1 wherein the first desiccant bed comprises a nanostructured porous material that adsorbs water from an air stream at a first pressure and releases water when subjected to a second pressure wherein the second pressure is lower than the first pressure.

9. The apparatus of claim 2 wherein the first and second desiccant beds comprise a nanostructured porous material that adsorbs water from an air stream at a first pressure and releases water when subjected to a second pressure wherein the second pressure is lower than the first pressure.

10. The apparatus of claim 8 wherein the nanostructured porous material comprises a metal-organic framework material.

11. The apparatus of claim 10 wherein the metal-organic framework material is selected from the group consisting of Fe-MIL-100, MOF-303, MOF-801, MOF-841, and combinations thereof.

12. The apparatus of claim 6 wherein the first recovery desiccant bed comprises a nanostructured porous material that adsorbs water from an air stream at a first pressure and releases water when subjected to a second pressure wherein the second pressure is lower than the first pressure.

13. The apparatus of claim 7 wherein the first and second recovery desiccant beds comprise a nanostructured porous material that adsorbs water from an air stream at a first pressure and releases water when subjected to a second pressure wherein the second pressure is lower than the first pressure.

14. The apparatus of claim 12 wherein the nanostructured porous material comprises a metal-organic framework material.

15. The apparatus of claim 12 wherein the metal-organic framework material is selected from the group consisting of Fe-MIL-100, MOF-303, MOF-801, MOF-841, and combinations thereof.

16. The apparatus of claim 1 wherein the first moisture-responsive CO₂ sorbent bed comprises a porous carbon material that is functionalized with quaternary ammonium groups.

17. The apparatus of claim 2 wherein the first and second moisture-responsive CO₂ sorbent beds comprise a porous carbon material that is functionalized with quaternary ammonium groups.

18. The apparatus of claim 2 wherein the first and second trains are sealed from each other.

19. The apparatus of claim 3 wherein at least one heat transfer pipe thermally couples the first desiccant bed to the second desiccant bed.

20. The apparatus of claim 2 further comprising a vacuum source alternately in communication with the first desiccant bed and then the second desiccant bed.

21. The apparatus of claim 20 further comprising a CO₂ compressor alternately in communication with the first moisture-responsive CO₂ sorbent bed and then the second moisture-responsive CO₂ sorbent bed.

22. The apparatus of claim 1 further comprising a condenser positioned downstream of and in communication with first moisture-responsive CO₂ sorbent bed, a vacuum pump positioned downstream of and in communication with the condenser, and a CO₂ compressor positioned downstream of and in communication with the vacuum pump.

23. A method comprising operating the apparatus of claim 1 in (A) adsorption mode to remove water and CO₂ from a first air stream and (B) regeneration mode to release adsorbed water and CO₂,
wherein adsorption mode comprises:
(a) contacting the first air stream with the first desiccant bed to reduce the water content of the stream and create a second air stream having a reduced water content relative to the first stream;
(b) contacting the second air stream with the first moisture-responsive CO₂ sorbent bed to reduce the CO₂ content of the stream and release water from the bed to create a third stream having a reduced CO₂ content relative to the first and second air streams, and a water content that is higher than the water content of the second stream but lower than the water content of the first stream; and
(c) exhausting the third stream to ambient atmosphere; and
wherein regeneration mode comprises:
(a) releasing water adsorbed by the first desiccant bed to create a water vapor stream;
(b) contacting the water vapor stream with the first moisture-responsive CO₂ sorbent bed to release CO₂ adsorbed by the bed and to adsorb water from the water vapor stream to create a discharge stream comprising water vapor and CO₂; and
(c) passing the discharge stream through one or more condensers and compressors to create (i) a liquid water condensate discharge and (ii) a CO₂ stream.

24. The method of claim 23 wherein the apparatus further comprises a first recovery desiccant bed arranged downstream of and in communication with the first moisture-responsive CO₂ sorbent bed, the method further comprising contacting the third air stream with a recovery desiccant bed to reduce the water content of the third air stream before exhausting it to ambient atmosphere.

25. A method comprising operating the apparatus of claim 2 in (A) adsorption mode to remove water and CO₂ from a first air stream and (B) regeneration mode to release adsorbed water and CO₂,
wherein adsorption mode comprises:
(a) contacting the first air stream with the first desiccant bed to reduce the water content of the stream and create a second air stream having a reduced water content relative to the first stream;
(b) contacting the second air stream with the first moisture-responsive CO₂ sorbent bed to reduce the CO₂ content of the stream and release water from the bed to create a third stream having a reduced CO₂ content relative to the first and second air streams, and a water content that is higher than the water content of the second stream but lower than the water content of the first stream; and
(c) exhausting the third stream to ambient atmosphere; and
wherein regeneration mode comprises:
(a) releasing water adsorbed by the first desiccant bed to create a water vapor stream;
(b) contacting the water vapor stream with the first moisture-responsive CO₂ sorbent bed to release CO₂ adsorbed by the bed and to adsorb water from the water vapor stream to create a discharge stream comprising water vapor and CO₂; and
(c) passing the discharge stream through one or more condensers and compressors to create (i) a liquid water condensate discharge and (ii) a CO₂ stream.

26. The method of claim 25 comprising operating the apparatus such that the first train operates in adsorption mode when the second train operates in regeneration mode and the second train operates in adsorption mode when the first train operates in regeneration mode.
